(19) United States
(12) Patent Application Publication
(10) Pub. No.: US 2010/0266048 A1
(43) Pub. Date: Oct. 21, 2010

(54) VIDEO ENCODING AND DECODING METHOD AND DEVICE, AND VIDEO PROCESSING SYSTEM

(75) Inventors: Haitao Yang, Shenzhen (CN); Sixin Lin, Shenzhen (CN); Shan Gao, Shenzhen (CN); Yingjia Liu, Shenzhen (CN); Jiali Fu, Shenzhen (CN); Jiantong Zhou, Shenzhen (CN)

Correspondence Address: Docket Clerk/HTCL, P.O. Drawer 800889, Dallas, TX, 75380, US

(73) Assignee: Huawei Technologies Co., Ltd.

(21) Appl. No.: 12/830,126

(22) Filed: Jul. 2, 2010

Related U.S. Application Data
(63) Continuation of application No. PCT/CN2008/073291, filed on Dec. 2, 2008.

(30) Foreign Application Priority Data
Jan. 4, 2008 (CN) 200810002806.9

(51) Int. Cl. H04N 7/26

(52) U.S. Cl. 375/240.24; 375/E07.209

(57) ABSTRACT

A video encoding and decoding method and device and a video processing system are provided. In the encoding method and device, ordinate and abscissa position information of each block in a searching area is established by selecting an appropriate origin of coordinates of the searching area; meanwhile, an offset of a current macro block is encoded by using information of peripheral blocks of the macro block encoded currently as a context for encoding position offset information of a corresponding macro block in an adjacent view reference image of the current macro block. In the decoding method and device, position information of a corresponding macro block in a coordinate system is obtained by parsing offset information of the corresponding macro block of the current macro block, and motion information of the corresponding macro block is used as motion information of the current macro block. So the coding efficiency is increased.

### CROSS-REFERENCE TO RELATED APPLICATIONS

This application is a continuation of International Application No. PCT/CN2008/073291, filed on Dec. 2, 2008, which claims priority to Chinese Patent Application No. 200810002806.9, filed on Jan. 4, 2008, both of which are hereby incorporated by reference in their entireties.

### TECHNICAL FIELD

The present invention relates to the field of video technologies, and more particularly to a video encoding method and a video encoding device, a video decoding method and a video decoding device, and a video processing system.

### BACKGROUND

With the development of multimedia communications technologies, the conventional fixed view-point visual sense and 2D plane visual sense cannot satisfy high demands of the people for video playing. In many application fields such as entertainment, education, tourism, and surgery, the demands on the free view-point video and 3D video are proposed, for example, a free view-point television (FTE) allowing viewers to select viewing angles, and a 3 dimensional television (3DTV) providing video at different viewing angles for the viewers at different positions. Currently, in the joint multiview video coding (MVC) technology standards compatible with H.264/AVC which is being developed by the Joint Video Team of ITU and MPEG, a joint multiview video model (JMVM) adopts a motion skip mode (MSM) predicted between view-points. In the technology, by using a high similarity of the motion in the adjacent view-point views, the motion information in the adjacent view-point views is used for encoding the current view-point view, so as to save bit resources required for encoding the motion information of some macro blocks in the image, and thus compression efficiency of the MVC is improved.

The MSM technology mainly includes the following two steps, namely, calculating global disparity vector (GDV) information, and calculating motion information of corresponding macro blocks in a reference image. As shown in FIG. 1, upper and lower blocks on two sides represent anchor pictures in adjacent views, and a plurality of non-anchor pictures may exist between anchor picture Img_{A} and anchor picture Img_{B}. FIG. 1 shows only one non-anchor picture Img_{cur}, and global disparity information GDV_{cur} of the non-anchor picture Img_{cur} may be obtained according to the formula GDV_{cur}=GDV_{A}. After the GDV_{cur} information of the current encoded image Img_{cur} is obtained, a macro block in an inter-view-point reference view image corresponding to each macro block in the non-anchor picture Img_{cur} may be determined according to the GDV_{cur} information, for example, the macro block in the inter-view-point reference view image corresponding to a macro block MB_{cur} in FIG. 1 is MB_{cor}, and motion information of the macro block MB_{cor} is used as motion information of the macro block MB_{cur} for performing motion compensation. The macro block corresponding to the reference picture is found in the view for prediction, so as to obtain residual data. Finally, an overhead RDCost_{MBcur, MSM} that uses the MSM mode is obtained through calculation; if the overhead of using the MSM mode is smaller than overheads of using other macro block modes, the MSM is selected as a final mode of the macro block.

In the above method, the corresponding macro block determined through the GDV_{cur} information may be not the corresponding macro block to achieve optimal encoding efficiency of the current macro block. In order to find the corresponding macro block capable of achieving the optimal encoding efficiency of the current macro block, the motion information of the corresponding macro block capable of achieving the optimal encoding efficiency of the current macro block may be searched within a searching scope preset in the reference image, so as to obtain the motion information of the current macro block. Specifically, as shown in FIG. 2, in the method, each block is searched within the searching scope by using an index identifier, where index numbers are respectively 0, 1, 2, and 3. When the current macro block MB is encoded, if the corresponding macro block MB′ capable of achieving the optimal encoding efficiency is found within the searching scope in the adjacent view-point, and it is assumed that the optimal macro block is the one having index number 5, when the current macro block MB is encoded, the index number “5” of the macro block MB′ is encoded as well.

In the above method, index information of the found corresponding macro block needs to be encoded, so information redundancy occurs. Further, the searching area is two-dimensional, but the index number encoding method in the method is one-dimensional position offset information, and respective statistic characteristics of the position offset information in horizontal and vertical directions is not disclosed, and thus the encoding efficiency is affected.

Further, in the prior art, the motion information of the corresponding macro block indicated by the GDV information in the front view reference image or the back view reference image is used as the motion information of the macro block encoded currently, for performing the motion compensation of the macro block encoded currently. However, due to the difference of the corresponding macro block in the front view reference image or the back view reference image, the encoding efficiency is low.

### SUMMARY

The present invention provides a video encoding method and a video encoding device, a video decoding method and a video decoding device, and a video processing system, which solve the problem of low encoding efficiency in the prior art, and achieve high efficiency encoding for video images.

In an embodiment, the present invention provides a video encoding method, which includes the following steps.

An image block corresponding to a current macro block is obtained in an adjacent view reference image according to disparity vector information.

A coordinate system of a reference image searching area of the image block is established according to the image block.

A corresponding macro block capable of achieving an optimal encoding efficiency of the current macro block is found in the searching area, and first offset information of the corresponding macro block in the coordinate system is obtained.

The first offset information is encoded.

In an embodiment, the present invention provides a video decoding method, which includes the following steps.

Received code stream information is parsed, and first offset information of a macro block corresponding to a current macro block in an adjacent view reference image of the current macro block is obtained.

An image block corresponding to the current macro block is obtained in the adjacent view reference image according to disparity vector information.

Coordinate information of the macro block corresponding to the current macro block is obtained according to the first offset information, in a coordinate system of a reference image searching area established according to the image block.

Motion information of the macro block corresponding to the current macro block is obtained according to the coordinate information, and motion compensation is performed by using the motion information.

In an embodiment, the present invention provides a video encoding device, which includes a first module, a second module, and a third module.

The first module is configured to obtain an image block corresponding to a current macro block and having a size the same as a preset searching precision in an adjacent view reference image according to disparity vector information of the preset searching precision.

The second module is configured to obtain first offset information of a corresponding macro block capable of achieving an optimal encoding efficiency of the current macro block in a coordinate system established according to the image block.

The third module is configured to encode the first offset information.

In an embodiment, the present invention provides a video decoding device, which includes a fifth module, a sixth module, a seventh module, and an eighth module.

The fifth module is configured to parse the received code stream information, and obtain first offset information of a macro block corresponding to a current macro block in an adjacent view reference image of the current macro block.

The sixth module is configured to obtain an image block corresponding to the current macro block in the adjacent view reference image according to disparity vector information.

The seventh module is configured to obtain coordinate information of the macro block corresponding to the current macro block according to the first offset information, in a coordinate system of a reference image searching area established according to the image block.

The eighth module is configured to obtain motion information of the macro block corresponding to the current macro block according to the coordinate information, and perform motion compensation by using the motion information.

In an embodiment, the present invention provides a video processing system, which includes a video encoding device and a video decoding device. The video encoding device includes a first module, a second module, and a third module.

The first module is configured to obtain an image block corresponding to a current macro block and having a size the same as a preset searching precision in an adjacent view reference image according to disparity vector information of the preset searching precision.

The second module is configured to obtain first offset information of a corresponding macro block capable of achieving an optimal encoding efficiency of the current macro block in a coordinate system established according to the image block.

The third module is configured to encode the first offset information.

The video decoding device includes a fifth module, a sixth module, a seventh module, and an eighth module.

The fifth module is configured to parse received code stream information, and obtain the first offset information of the macro block corresponding to the current macro block in the adjacent view reference image of the current macro block.

The sixth module is configured to obtain the image block corresponding to the current macro block in the adjacent view reference image according to the disparity vector information.

The seventh module is configured to obtain coordinate information of the macro block corresponding to the current macro block according to the first offset information, in the coordinate system of a reference image searching area established according to the image block.

The eighth module is configured to obtain motion information of the macro block corresponding to the current macro block according to the coordinate information, and perform motion compensation by using the motion information.

In an embodiment, the present invention provides a video encoding method, which includes the following steps.

Exclusive-OR (XOR) processing is performed on a marking symbol for indicating a front or back view of a current macro block and a marking symbol of one or more peripheral macro blocks.

A context model is established according to the marking symbol of the one or more peripheral macro blocks, and the marking symbol information after the XOR processing is encoded by using the context model.

With the video encoding method and the video encoding device, the video decoding method and the video decoding device, and the video processing system, ordinate and abscissa position information of each block in a searching area is established by selecting an appropriate origin of coordinates of the searching area. Meanwhile, an offset of a current macro block is encoded by using information of peripheral blocks of the macro block encoded currently as the context for encoding position offset information of a corresponding macro block in an adjacent view reference image of the current macro block. In this way, the encoding efficiency is increased.

### BRIEF DESCRIPTION OF THE DRAWINGS

FIG. 1 is a schematic view of a GDV deduction encoding process in the prior art;

FIG. 2 is a schematic view of a position information encoding process within a searching area scope in the prior art;

FIG. 3 is a flow chart of a video encoding method according to a first embodiment of the present invention;

FIG. 4 is a schematic view of selecting an origin of coordinates of a searching area and encoding an offset in a second embodiment of the video encoding method according to the present invention;

FIG. 5 is a schematic view of encoding offset coordinates of a corresponding macro block of a current macro block in the second embodiment of the video encoding method according to the present invention;

FIG. 6 is a schematic view of selecting an origin of coordinates of a searching area and encoding an offset in a third embodiment of the video encoding method according to the present invention;

FIG. 7 is a flow chart of a video decoding method according to an embodiment of the present invention;

FIG. 8 is a schematic structural view of a video encoding device according to a first embodiment of the present invention;

FIG. 9 is a schematic structural view of the video encoding device according to a second embodiment of the present invention;

FIG. 10 is a schematic structural view of a video decoding device according to a first embodiment of the present invention;

FIG. 11 is a schematic structural view of the video decoding device according to a second embodiment of the present invention;

FIG. 12 is a schematic structural view of a video processing system according to a first embodiment of the present invention; and

FIG. 13 is a schematic structural view of the video processing system according to a second embodiment of the present invention.

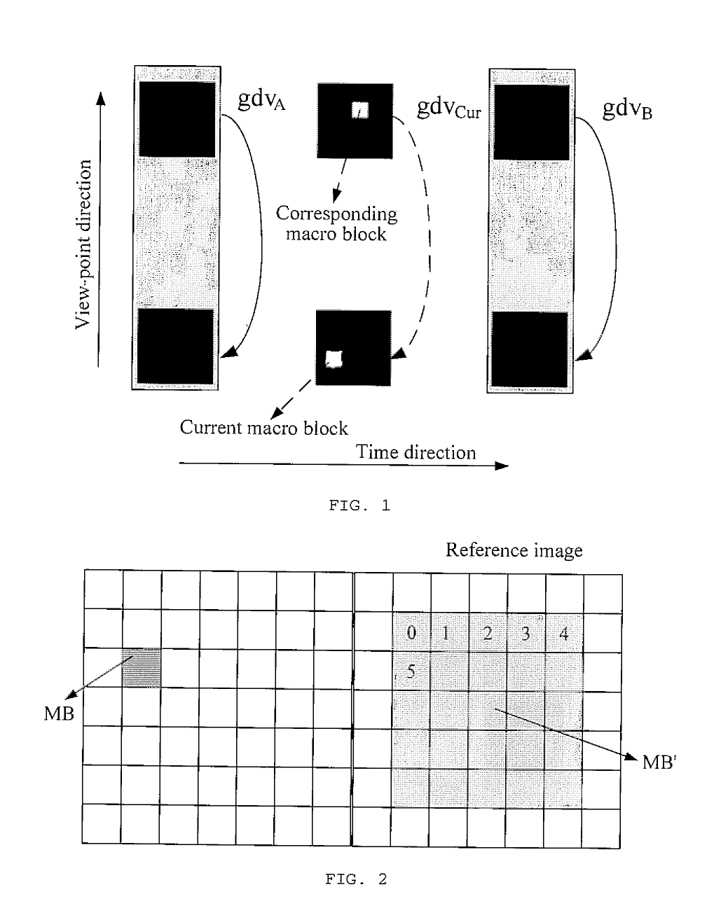

### DETAILED DESCRIPTION

Technical solutions of embodiments of the present invention are further described in the following with reference to the accompanying drawings and embodiments.

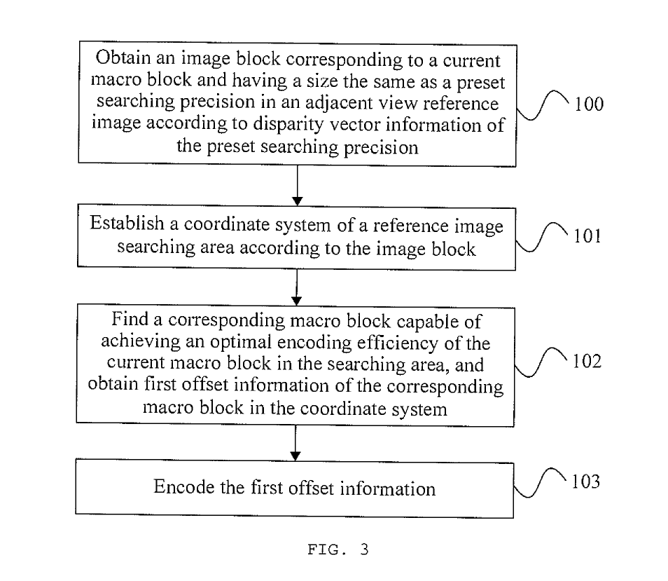

FIG. 3 is a flow chart of a video encoding method according to a first embodiment of the present invention. Referring to FIG. 3, the method includes the following steps.

In step 100, an image block corresponding to a current macro block and having a size the same as a preset searching precision is obtained in an adjacent view reference image according to disparity vector information of the preset searching precision.

In an MSM mode, due to a high similarity of motions in adjacent view-point views, motion information of a corresponding macro block capable of achieving an optimal encoding efficiency of the current macro block in the adjacent view reference image of the current macro block to be encoded may be used as motion information of the current macro block, so that the corresponding macro block satisfying relevant requirements needs to be found in the reference image. Firstly, according to the disparity vector information of the preset searching precision, which, for example, is an 8×8 pixel precision or a 16×16 pixel precision, an image block having a size the same as the searching precision is initially positioned in the adjacent view reference image of the current macro block, that is, an 8×8 image block is initially positioned in the adjacent view reference image of the current macro block according to the disparity vector information of the 8×8 pixel precision, or a 16×16 image block is initially positioned in the adjacent view reference image of the current macro block according to the disparity vector information of the 16×16 pixel precision.

In step 101, a coordinate system of a reference image searching area is established according to the image block.

After an image block is initially positioned in the adjacent view reference image of the current macro block, the coordinate system is established in the reference image searching area according to the positioned image block. The scope of the reference image searching area is predefined, and the searching area includes the positioned image block. A 2D coordinate system is established in the reference image searching area according to the positioned image block. Specifically, when the positioned image block is an 8×8 or 4×4 image block, the image block or the first 8×8 or 4×4 image block of the macro block of the image block is used as an origin of coordinates of the coordinate system of the reference image searching area, or the 8×8 or 4×4 image block is used as the origin of coordinates of the coordinate system of the reference image searching area. When the positioned image block is a 16×16 image block, the image block is used as the origin of coordinates of the coordinate system of the reference image searching area. It can be known from the above description that the sizes of the image blocks found in the reference image are different, so the origin of coordinates of the coordinate system may be determined in different ways. Of course, the present invention is not limited to the above manner of determining the origin of coordinates, and a peripheral image block or the macro block of the positioned image block may be used as the origin of coordinates of the coordinate system of the reference image searching area.

In step 102, a corresponding macro block capable of achieving an optimal encoding efficiency of the current macro block is found in the searching area, and first offset information of the corresponding macro block in the coordinate system is obtained.

After the origin of coordinates of the coordinate system is determined, the corresponding macro block capable of achieving the optimal encoding efficiency of the current macro block is searched one by one from left to right and from top to bottom in the scope of the reference image searching area. Specifically, the motion information is predicted for each macro block, residual information is obtained according to the motion information of the current macro block, and then bit overhead information in the MSM mode is calculated. If the bit overhead of a macro block is the smallest, the macro block is used as the corresponding macro block capable of achieving the optimal encoding efficiency of the current macro block in the scope of the reference image searching area. After the corresponding macro block capable of achieving the optimal encoding efficiency of the current macro block is determined, first coordinate information of the corresponding macro block in the established coordinate system is obtained, where the first coordinate information includes the first offset information in a horizontal direction and a vertical direction of the corresponding macro block relative to the origin of the coordinate system.

In step 103, the first offset information is encoded.

In the MSM mode, the motion information of the corresponding macro block capable of achieving the optimal encoding efficiency of the current macro block in the adjacent view reference image of the current macro block is used as the motion information of the current macro block; before the current macro block is encoded, the motion information of all the macro blocks in the adjacent view reference image of the current macro block is encoded, that is, the motion information of the corresponding macro block for motion compensation of the current macro block is encoded. Therefore, as long as the offset information of the corresponding macro block in the reference image relative to the origin of coordinates is encoded, and is notified to a decoder, the decoder can correctly locate the corresponding macro block according to the offset information, and extract the decoded motion information of the corresponding macro block as the motion information of the current macro block.

After the first offset information of the corresponding macro block in the reference image of the current macro block is obtained, the first offset information for indicating the offset is encoded. Firstly, offset information of the corresponding macro blocks in the reference image of the macro blocks of the peripheral blocks of the current macro block is firstly determined, for example, second offset information of the corresponding macro block in the reference image of the macro block of a left block of the current macro block, and third offset information of the corresponding macro block in the reference image of the macro block of an upper block of the current macro block are determined; then, an encoding context is constructed according to the obtain second and third offset information; finally, the first offset information of the corresponding macro block in the reference image of the current macro block is encoded according to the constructed encoding context. Specifically, after the encoding context is constructed according to the obtained second and third offset information, an horizontal offset and a vertical offset in the first offset information are binarized according to truncated unary code or exponential-Golomb code to obtain binary bit stream information, and the binary bit stream including the binarized information is sent to an arithmetic encoder for arithmetic encoding according to the encoding context information, or each component of the first offset information is directly encoded to a code stream by using the truncated unary code or the exponential-Golomb code.

The first offset information of the corresponding macro block in the reference image of the current macro block according to the constructed encoding context may also be encoded as follows. The second offset information and the third offset information of the corresponding macro blocks in the reference image of the macro blocks of the left block and the upper block of the current macro block are firstly determined. The corresponding components of the second offset information and the third offset information are averaged, that is, horizontal offset components in the second offset information and the third offset information are averaged to obtain an average value in the horizontal direction, and vertical offset components in the second offset information and the third offset information are averaged to obtain an average value in the vertical direction. Then, the corresponding component of the first offset information is predicted by using the obtained horizontal offset average value and the vertical offset average value, and predicted residual information is obtained. Afterwards, the encoding context information is constructed according to the second offset information and the third offset information, and the predicted residual information is encoded by using the encoding context information. Specifically, for the obtained predicted residual information, the offset information is binarized according to the truncated unary code or the exponential-Golomb code, and then the code stream including the binarized information is sent to the arithmetic encoder for arithmetic encoding according to the encoding context information, or each component of the first offset information is directly encoded to the code stream by using the truncated unary or the exponential-Golomb code.

To find the corresponding macro block capable of achieving the optimal encoding efficiency of the current macro block in the scope of the reference image searching area, the corresponding macro block may be found in a front view reference image or a back view reference image. Therefore, when the current macro block is encoded, a decoding end needs to be distinctly notified whether the corresponding macro block is in the front view or back view reference image, so that the decoding end can correctly locate the corresponding macro block. Accordingly, after the first offset information is encoded, marking symbol information for indicating the front or back view is encoded. Specifically, Exclusive-OR (XOR) processing is performed on the marking symbol of the current macro block and marking symbol of one or more peripheral macro blocks, a context model is established according to the marking symbol of one or more peripheral macro blocks, and the marking symbol information after the XOR processing is encoded. In the embodiment of the method, common processing methods for persons skilled in the art may be used in the encoding.

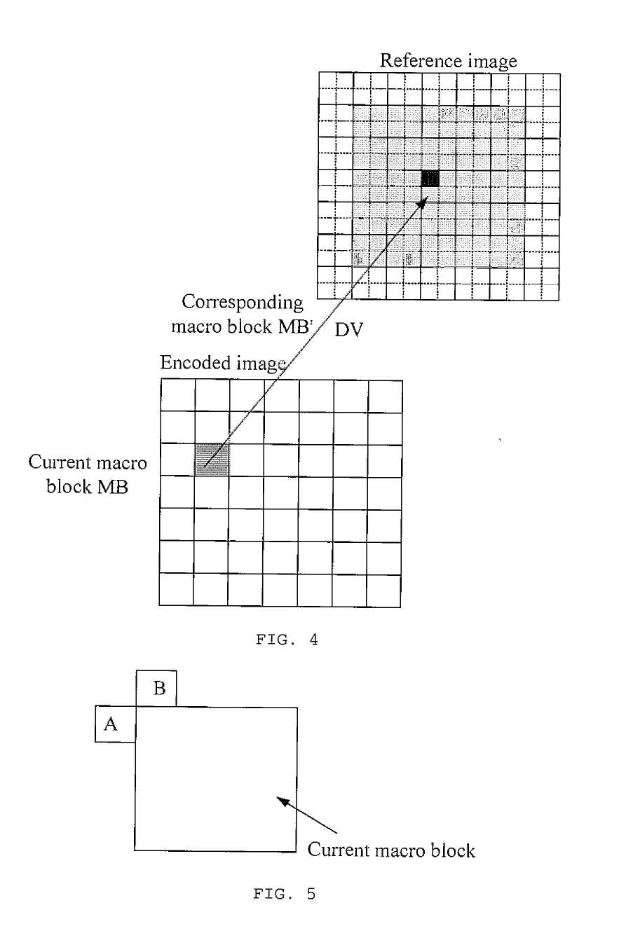

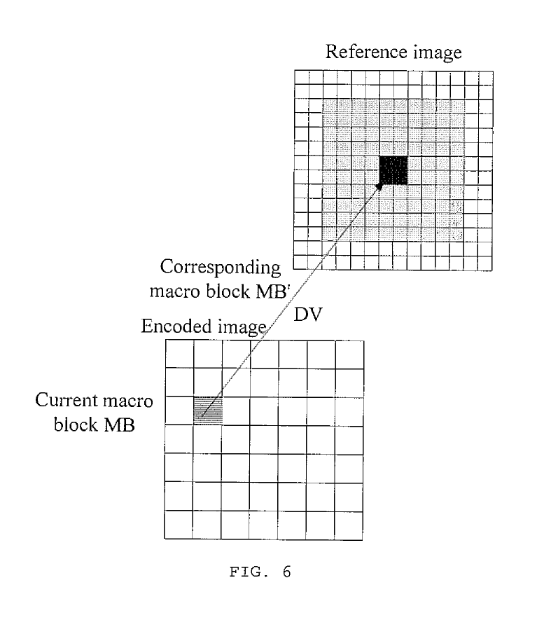

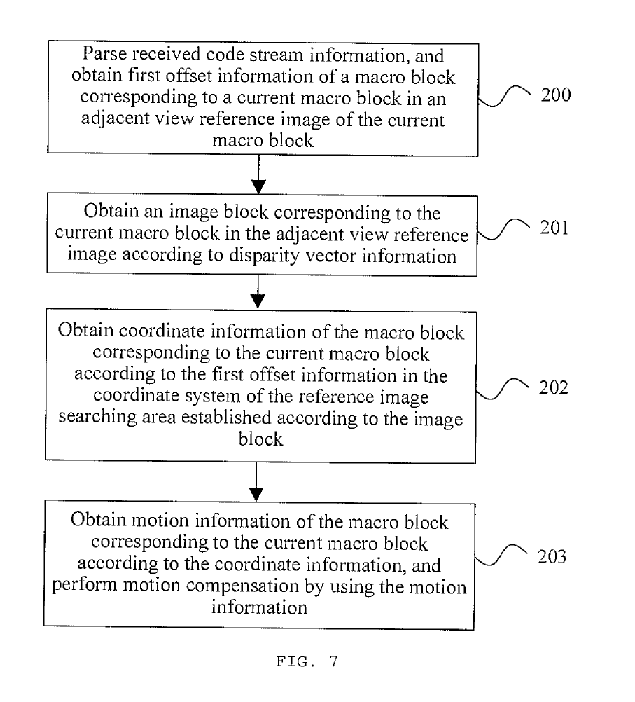

FIG. 4 is a schematic view of selecting an origin of coordinates of a searching area and encoding an offset in a second embodiment of the video encoding method according to the present invention. Referring to FIG. 4, a block (indicated by an arrow) is initially positioned in an adjacent view reference image of a current macro block MB according to a disparity vector of an 8×8 pixel precision, and a coordinate system is established in a searching area indicated by a shadow part by using the first 8×8 image block (indicated by a black block in the drawing) of a macro block of the 8×8 image block as an origin of coordinates. A corresponding macro block capable of achieving an optimal encoding efficiency of the current macro block is found in the searching area, for example, coordinates of the corresponding macro block MB′ are (horOffset, verOffset). FIG. 5 is a schematic view of encoding offset coordinates of the corresponding macro block of the current macro block in the second embodiment of the video encoding method according to the present invention. Referring to FIG. 5, encoding context information is constructed by using the offset coordinates of the corresponding macro blocks of the macro blocks of a left block A and an upper block B peripheral to the current macro block, where the left block A and the upper block B are 4×4 image blocks. The two coordinate components “horOffset” and “verOffset” of the current macro block are encoded. As the selected origin of coordinates is located at a center of the searching area, absolute values of a horizontal component and a vertical component of the offset of the corresponding macro block have a fixed upper limit. For example, in FIG. 5, the absolute values of the horizontal component and the vertical component of the offset will not exceed “4”. After the encoding context is selected by using the offset information of the left block A and the upper block B, the “horOffset” and the “verOffset” are respectively binarized according to truncated unary code, and then the binarized code stream is sent to an arithmetic encoder for arithmetic encoding according to the constructed context model. Pseudo code of the encoding procedure is given in the following. xWriteOffsetComponent (Short sOffsetComp, absolute value sum uiAbsSum of offset components UInt A and B, UInt context index uiCtx)

```
{
    //--- set context ---
    UInt uiLocalCtx = uiCtx;
    if(uiAbsSum >= 3)
    {
    uiLocalCtx += ( uiAbsSum > 5) ? 3 : 2;
}
//--- First symbol is non-zero or not---
UInt uiSymbol = ( 0 == sOffsetComp) ? 0 : 1;
writeSymbol( uiSymbol, m_cOffsetCCModel.get( 0, uiLocalCtx ) ) ;
ROTRS( 0 == uiSymbol, Err::m_nOK );
//--- Non-zero absolute value sum symbol
UInt uiSign = 0;
if( 0 > sOffsetComp )
{
    uiSign = 1;
    sOffsetComp = −sOffsetComp;
}
```

Binarization (sOffsetComp−1) is performed according to the truncated unary code, and the arithmetic encoding is performed according to a context model;

If the searching is performed in the front view reference image and the back view reference image, the marking symbol for indicating the front or back view needs to be encoded. After the XOR processing is performed on the marking symbol “currFlag” of the macro block encoded currently and the marking symbol “leftFlag” of the one or more peripheral macro blocks, the context model is established for context adaptive arithmetic encoding. The pseudo code is given in the following.

uiSymbol=currFlag XOR leftFlag;

uiCtx=(leftFlag==LIST_{—}0)?0:1;

uiCtx+=(aboveFlag==LIST_{—}0)?0:1;

writeSymbol(uiSymbol,MotionSkipListXFlagCCModel.get(0,uiCtx));

In the implementation of the method, the 8×8 image block initially positioned in the adjacent view reference image according to the disparity vector of the 8×8 pixel precision may also be used as the origin of coordinates of the coordinate system. Although the origin of coordinates may be determined in different ways, the subsequent procedures of encoding the offset information of the corresponding macro block of the current macro block are the same.

FIG. 6 is a schematic view of selecting an origin of coordinates of a searching area and encoding an offset in a third embodiment of the video encoding method according to the present invention. Referring to FIG. 6, a 16×16 block is initially positioned in an adjacent view reference image of a current macro block MB according to a disparity vector of an 16×16 pixel precision, and a 2D coordinate system is established in a searching area indicated by a shadow part by using a macro block of the 16×16 block (indicated by a black block in the drawing) as an origin of coordinates. A corresponding macro block capable of achieving an optimal encoding efficiency of the current macro block is found in the searching area, for example, coordinates of the found optimal corresponding macro block MB′ are (horOffset, verOffset). Referring to FIG. 5, the “horOffset” and “verOffset” are predicted by using average values of the corresponding components of the offsets of the left block A and the upper block B of the current macro block, so as to obtain predicted residual ΔhorOffset and ΔverOffset. Then, the encoding context is selected by using the offset information of the left block A and the upper block B, the ΔhorOffset and ΔverOffset are binarized according to the exponential-Golomb code, and then the binarized code stream is sent to an arithmetic encoder for arithmetic encoding. In this embodiment, the method for encoding the marking symbol of the macro block encoded currently is the same as that of the above embodiment, and will not be described again here.

In the embodiments of the video encoding method, ordinate and abscissa position information of each block in a searching area is established by selecting an appropriate origin of coordinates of the searching area; meanwhile, an offset of a current macro block is encoded by using information of peripheral blocks of the macro block encoded currently as a context for encoding position offset information of a corresponding macro block in an adjacent view reference image of the current macro block, so that the encoding efficiency is increased.

### Embodiment of a Video Decoding Method

FIG. 7 is a flow chart of a video decoding method according to an embodiment of the present invention. Referring to FIG. 7, the method includes the following steps.

In step 200, received code stream information is parsed, and first offset information of a macro block corresponding to a current macro block in an adjacent view reference image of the current macro block is obtained.

After receiving the code stream information, a decoding end parses the included information, and obtains offset information of the corresponding macro block in the adjacent view reference image of the macro block decoded currently, where the corresponding macro block is a macro block capable of achieving an optimal encoding efficiency of the current macro block in the reference image. Specifically, the process for parsing and obtaining the first offset information may be as follows: Second offset information and third offset information of the corresponding macro blocks in the reference image of the macro blocks of a left block and an upper block of the current macro block are firstly determined, decoding context information is obtained according to the obtained second offset information and the obtained third offset information, and an arithmetic decoder solves each bit of the first offset information according to the obtained decoding context information, so as to obtain the first offset information. During the procedure for parsing each bit, the offset information of the corresponding macro block of the current macro block, that is, offsets in a horizontal direction and a vertical direction of the corresponding macro block, may be parsed by a decoder using truncated unary code or exponential-Golomb code.

Further, in the procedure for parsing and obtaining the first offset information, the second offset information and the third offset information of the corresponding macro blocks in the reference image of the macro blocks of the left block and the upper block of the current macro block are firstly determined, the decoding context information is obtained according to the obtained second offset information and third offset information, and then predicted residual information of the corresponding macro block is parsed and obtained according to the decoding context information. During the procedure, each bit of the predicted residual information is obtained according to the decoding context information by the decoder using the truncated unary code or the exponential-Golomb code, and the predicted residual information of the corresponding macro block in the reference image of the macro block decoded currently is finally obtained. Then, corresponding components of the second offset information and the third offset information are averaged, two average values in the horizontal direction and the vertical direction are obtained, and the offset information, that is, the offsets in the horizontal direction and the vertical direction, of the corresponding macro block of the current macro block is obtained according to the average values and the obtained predicted residual information.

In step 201, an image block corresponding to the current macro block is obtained in the adjacent view reference image according to disparity vector information.

After the offset information of the corresponding macro block is obtained, an origin of coordinates needs to be determined, that is, it is necessary to determine the obtained offset is relative to which block. A procedure for establishing a coordinate system of the reference image searching area is the same as the procedure for establishing the coordinate system in the encoding method, that is, according to disparity vector information of a preset searching precision, the image block corresponding to the current macro block and having a size the same as the preset searching precision is obtained in the adjacent view reference image, and the coordinate system of the reference image searching area is established according to the image block. An encoding end and a decoding end agree on the rule for selecting the origin of coordinates when establishing the coordinate system in advance, that is, the two ends use the consistent rule for selecting the origin of coordinates. The coordinate system established by the decoding end according to the image block is completely the same as the coordinate system established by the encoding end according to the image block.

In step 202, coordinate information of the macro block corresponding to the current macro block is obtained according to the first offset information in the coordinate system of the reference image searching area established according to the image block.

After the coordinate system is established, the coordinate information of the corresponding macro block in the coordinate system may be determined based on the origin of coordinates and the first offset information, and the specific position of the corresponding macro block in the reference image of the macro block decoded currently is determined.

In step 203, motion information of the macro block corresponding to the current macro block is obtained according to the coordinate information, and motion compensation is performed by using the motion information.

As the motion information of all the macro blocks in the reference image are decoded, after the position of the corresponding macro block is determined, the motion information of the corresponding macro block is extracted from the decoding information of the reference image as the motion information of the macro block decoded currently, and is used in the motion compensation of the current macro block.

If the received code stream has encoding information of a marking symbol for indicating a front or back view, before step 200, the method further includes a procedure for parsing the marking symbol information for indicating the front or back view. Specifically, a context model is established according to a marking symbol of one or more peripheral macro blocks of the current macro block, identification information of the marking symbol is parsed, where the identification information of the marking symbol is result information of XOR processing on the marking symbol of the current macro block and the marking symbol of the one or more peripheral macro blocks. After the identification information of the marking symbol is parsed, the XOR processing is performed on the parsing result, so as to obtain the marking symbol information for indicating the front or back view.

In the video decoding method according to the embodiment, position information of the corresponding macro block in the coordinate system is obtained by parsing the offset information of the corresponding macro block of the current macro block, and the motion information of the corresponding macro block is used as the motion information of the current macro block, so that the decoding efficiency is increased.

In an embodiment, the present invention further provides a video encoding method, which includes the following steps.

In step 300, XOR processing is performed on a marking symbol for indicating a front or back view of a current macro block and a marking symbol of one or more peripheral macro blocks.

An encoding end determines to select a corresponding macro block of the current macro block in the front view or the back view reference image according to the above or existing determination conditions, and uses motion information of the selected corresponding macro block as motion information of the current macro block. Further, the marking symbol may indicate whether the front view reference image or the back view reference image is selected. The encoding end performs the XOR processing on the marking symbol for indicating the selected view reference image and the marking symbol of one or more peripheral macro blocks, and waits for the encoding.

In step 301, a context model is established according to the marking symbol of the one or more peripheral macro blocks, and the marking symbol information after the XOR processing is encoded by using the context model.

The context model is established by using the marking symbol of one or more peripheral macro blocks of the current macro block, the selected peripheral macro blocks are the same as the macro blocks selected in the above step, and the context model is established for performing context adaptive arithmetic encoding.

If the searching is performed in the front view reference image and the back view reference image, the marking symbol for indicating the front or back view needs to be encoded. After the XOR processing is performed on the marking symbol “currFlag” of the macro block encoded currently and the marking symbol “leftFlag” of the one or more peripheral macro blocks, the context model is established for performing the context adaptive arithmetic encoding. The pseudo code is given in the following.

uiSymbol=currFlag XOR leftFlag;

uiCtx=(leftFlag==LIST_{—}0)?0:1;

uiCtx+=(aboveFlag==LIST_{—}0)?0:1;

writeSymbol(uiSymbol,MotionSkipListXFlagCCModel.get(0,uiCtx));

Persons of ordinary skill in the art should understand that all or a part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be any medium that is capable of storing program codes, such as a Read-Only Memory (ROM), a Random Access Memory (RAM), a magnetic disk, or a Compact Disk Read-Only Memory (CD-ROM).

### Embodiments of a Video Encoding Device

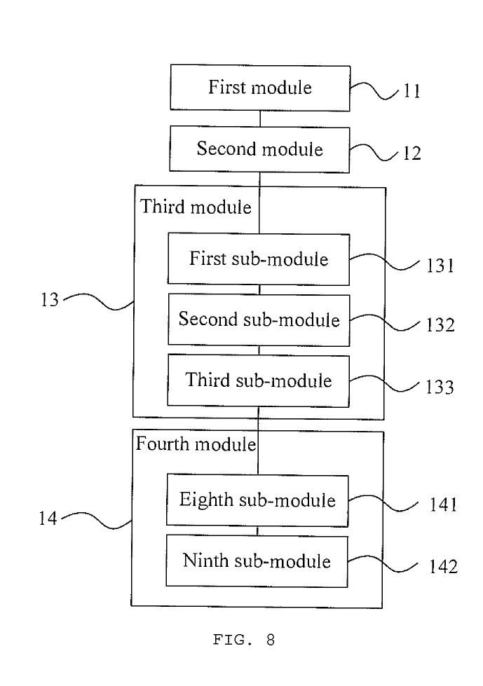

FIG. 8 is a schematic structural view of a video encoding device according to a first embodiment of the present invention. Referring to FIG. 8, the device includes a first module 11, a second module 12, and a third module 13. The first module 11 is configured to obtain an image block corresponding to a current macro block and having a size the same as a preset searching precision in an adjacent view reference image according to disparity vector information of the preset searching precision, the second module 12 is configured to obtain first offset information of a corresponding macro block capable of achieving an optimal encoding efficiency of the current macro block in a coordinate system established according to the image block, and the third module 13 is configured to encode the first offset information.

Specifically, the first module 11 in the video encoding device initially designates an image block in the reference image according to the disparity vector information of the searching precision, where the size of the image block is the same as that of the searching precision. Then, the second module 12 establishes a 2D coordinate system in a reference image searching area according to the image block, and thus, all the macro blocks in the reference image have position information according to the coordinate system. After the corresponding macro block capable of achieving the optimal encoding efficiency of the current macro block is found according to a certain searching sequence, the second module 12 obtains the first offset information of the corresponding macro block, that is, offset information relative to an origin of coordinates. The third module 13 encodes the first offset information. Specifically, the third module 13 includes a first sub-module 131, a second sub-module 132, and a third sub-module 133. The first sub-module 131 determines second offset information and third offset information of the corresponding macro blocks in the reference image of the macro blocks of respective peripheral blocks, for example, a left block and an upper block, of the current macro block, the second sub-module 132 is configured to obtain encoding context information according to the second offset information and the third offset information, and finally, the third sub-module 133 is configured to encode the first offset information by using the encoding context information.

In the first embodiment, the video encoding device further includes a fourth module 14, configured to encode marking symbol information for indicating a front or back view. Specifically, the fourth module 14 includes an eighth sub-module 141 and a ninth sub-module 142, where the eighth sub-module 141 performs XOR processing on the marking symbol for indicating the front or back view of the current macro block and a marking symbol of one or more peripheral macro blocks, and the ninth sub-module 142 is configured to establish a context model according to the marking symbol of the one or more peripheral macro blocks, and encode the marking symbol information after the XOR processing.

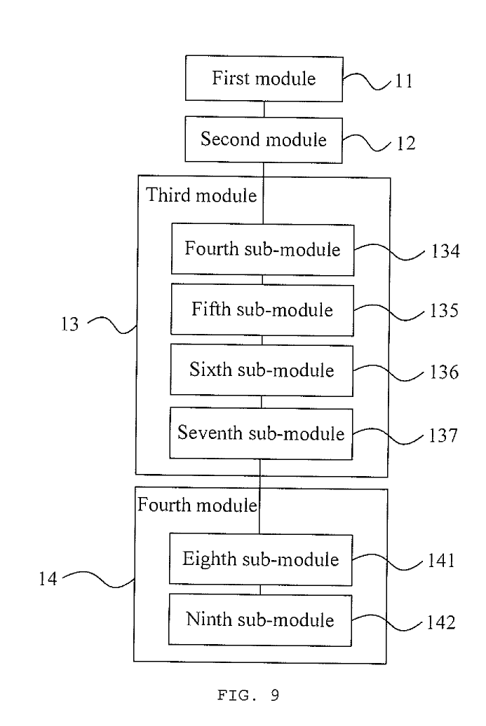

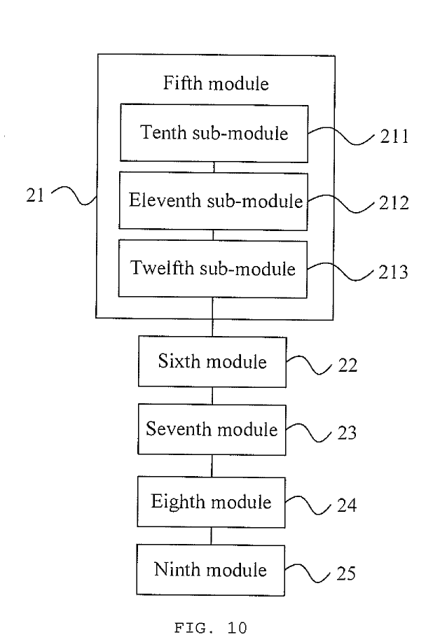

FIG. 9 is a schematic structural view of the video encoding device according to a second embodiment of the present invention. Referring to FIG. 9, the difference between the video encoding device of this embodiment and that of the first embodiment is as follows: In this embodiment, the third module 13 includes a fourth sub-module 134, a fifth sub-module 135, a sixth sub-module 136, and a seventh sub-module 137. The fourth sub-module 134 determines second offset information and third offset information of the corresponding macro blocks in the reference image of the macro blocks of respective peripheral blocks, for example, a left block and an upper block, of the current macro block, the fifth sub-module 135 averages corresponding components of the second offset information and the third offset information, and predicts the first offset information by using an averaging result, so as to obtain predicted residual information, the sixth sub-module 136 obtains encoding context information according to the second offset information and the third offset information, and the seventh sub-module 137 encodes the predicted residual information by using the encoding context information.

In the embodiments of the video encoding device, ordinate and abscissa position information of each block in a searching area is established by selecting an appropriate origin of coordinates of the searching area; meanwhile, an offset of a current macro block is encoded by using information of peripheral blocks of the macro block encoded currently as a context for encoding position offset information of a corresponding macro block in an adjacent view reference image of the current macro block, so that the encoding efficiency is increased.

### Embodiments of a Video Decoding Device

FIG. 10 is a schematic structural view of a video decoding device according to a first embodiment of the present invention. Referring to FIG. 10, the device includes a fifth module 21, a sixth module 22, a seventh module 23, and an eighth module 24. The fifth module 21 is configured to parse received code stream information, and obtain first offset information of a macro block corresponding to a current macro block in an adjacent view reference image of the current macro block, the sixth module 22 is configured to obtain an image block corresponding to the current macro block in the adjacent view reference image according to disparity vector information, the seventh module 23 is configured to obtain coordinate information of the macro block corresponding to the current macro block according to the first offset information in a coordinate system of a reference image searching area established according to the image block, and the eighth module 24 is configured to obtain motion information of the macro block corresponding to the current macro block according to the coordinate information, and perform motion compensation by using the motion information.

Specifically, after receiving the code stream information, the fifth module 21 in the device parses the received code stream information, and obtains the offset information of a corresponding macro block in the reference image of the macro block decoded currently. The seventh module 23 establishes a 2D coordinate system within the scope of the reference image searching area according to the image block found by the sixth module 22, so as to obtain the coordinate information of the corresponding macro block. The eighth module 24 extracts the motion information of the corresponding macro block from the motion information of all the decoded macro blocks of the reference image, and performs the motion compensation by using the motion information of the corresponding macro block as the motion information of the current macro block.

Further, the fifth module 21 includes a tenth sub-module 211, an eleventh sub-module 212, and a twelfth sub-module 213. The tenth sub-module 211 is configured to determine second offset information and third offset information of the corresponding macro blocks in the reference image of the macro blocks of respective peripheral blocks, for example, a left block and an upper block, of the current macro block, the eleventh sub-module 212 is configured to obtain decoding context information according to the second offset information and the third offset information, and the twelfth sub-module 213 is configured to parse the decoding context information to obtain the first offset information.

The device further includes a ninth module 25, configured to parse marking symbol information for indicating a front or back view. After receiving the code stream information, the ninth module 25 is used for parsing the marking symbol information in the code stream information, and determining the corresponding macro block of the macro block decoded currently is located in the reference mage of which view.

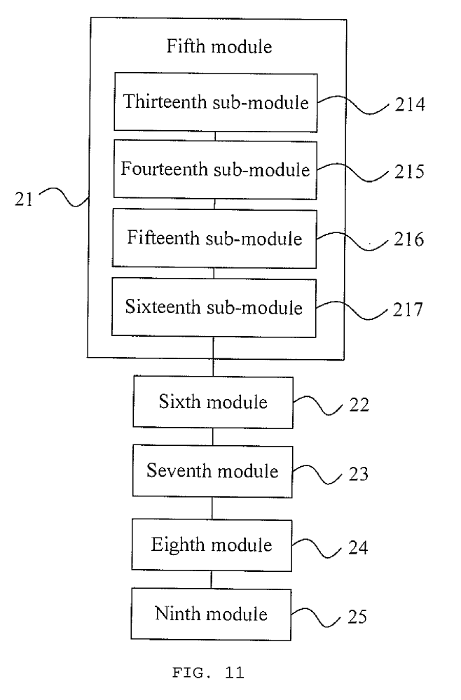

FIG. 11 is a schematic structural view of a second embodiment of the video decoding device according to the present invention. Referring to FIG. 11, the difference between the video decoding device according to the second embodiment and that of the first embodiment is as follows: The fifth module 21 includes a thirteenth sub-module 214, a fourteenth sub-module 215, a fifteenth sub-module 216, and a sixteenth sub-module 217. The thirteenth sub-module 214 is configured to determine second offset information and third offset information of the corresponding macro blocks in the reference image of the macro blocks of respective peripheral blocks, for example, a left block and an upper block, of the current macro block, the fourteenth sub-module 215 is configured to obtain decoding context information according to the second offset information and the third offset information, the fifteenth sub-module 216 is configured to parse the decoding context information to obtain predicted residual information of the corresponding macro block, and the sixteenth sub-module 217 is configured to average corresponding components of the second offset information and the third offset information, and obtain the first offset information of the corresponding macro block according to a processing result and the predicted residual information.

In the video decoding device according to the embodiments, position information of the corresponding macro block in the coordinate system is obtained by parsing the offset information of the corresponding macro block of the current macro block, and the motion information of the corresponding macro block is used as the motion information of the current macro block, so that the decoding efficiency is increased.

### Embodiments of a Video Processing System

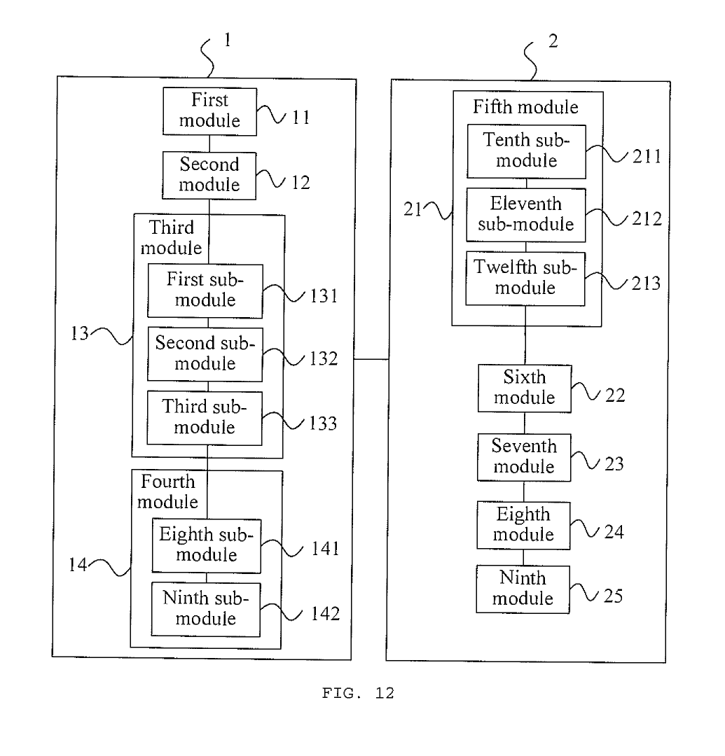

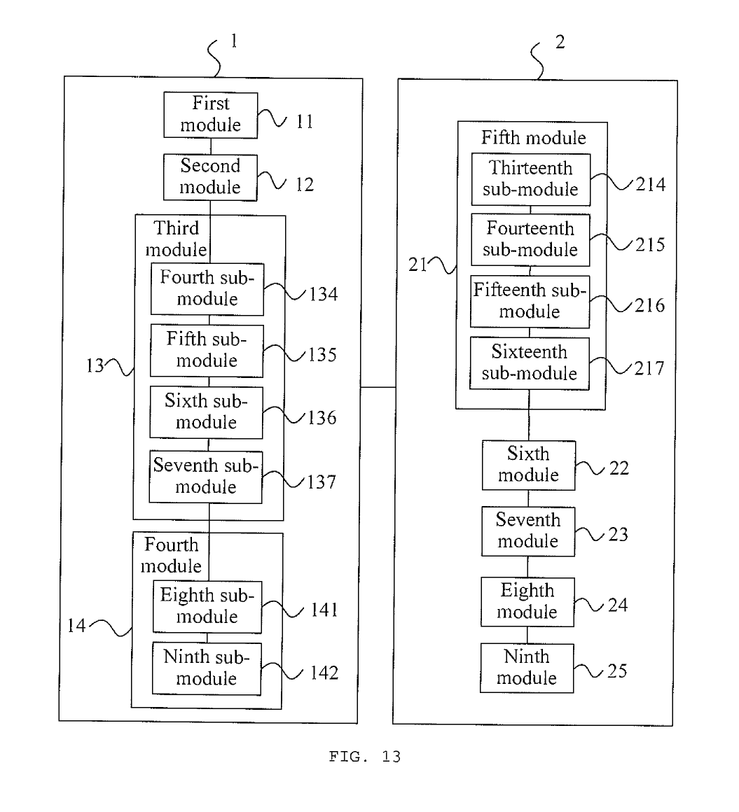

FIG. 12 is a schematic structural view of a video processing system according to a first embodiment of the present invention. Referring to FIG. 12, the system includes a video encoding device 1 and a video decoding device 2. The video encoding device 1 includes a first module 11, a second module 12, and a third module 13. The first module 11 is configured to obtain an image block corresponding to a current macro block and having a size the same as a preset searching precision in an adjacent view reference image according to disparity vector information of the preset searching precision, the second module 12 is configured to obtain first offset information of a corresponding macro block capable of achieving an optimal encoding efficiency of the current macro block in a coordinate system established according to the image block, and the third module 13 is configured to encode the first offset information.

Specifically, the first module 11 in the video encoding device initially designates an image block in the reference image according to the disparity vector information of the preset searching precision, where the size of the image block is the same as that of the searching precision. Then, the second module 12 establishes a 2D coordinate system in a reference image searching area according to the image block, and thus, all the macro blocks in the reference image have position information according to the coordinate system. After the corresponding macro block capable of achieving the optimal encoding efficiency of the current macro block is found according to a certain searching sequence, the second module 12 obtains the first offset information of the corresponding macro block, that is, offset information relative to an origin of coordinates. The third module 13 encodes the first offset information. Further, the third module 13 includes a first sub-module 131, a second sub-module 132, and a third sub-module 133. The first sub-module 131 determines second offset information and third offset information of the corresponding macro blocks in the reference image of the macro blocks of respective peripheral blocks, for example, a left block and an upper block, of the current macro block, the second sub-module 132 is configured to obtain encoding context information according to the second offset information and the third offset information, and finally, the third sub-module 133 is configured to encode the first offset information by using the encoding context information.

In the first embodiment of the video processing system, the video encoding device 1 further includes a fourth module 14, configured to encode marking symbol information for indicating a front or back view. Specifically, the fourth module 14 includes an eighth sub-module 141 and a ninth sub-module 142. The eighth sub-module 141 performs XOR processing on the marking symbol for indicating the front or back view of the current macro block and a marking symbol of one or more peripheral macro blocks, and the ninth sub-module 142 is configured to establish a context model according to the marking symbol of the one or more peripheral macro blocks, and encode the marking symbol information after the XOR processing.

The video decoding device 2 includes a fifth module 21, a sixth module 22, a seventh module 23, and an eighth module 24. The fifth module 21 is configured to parse received code stream information, and obtain the first offset information of the macro block corresponding to the current macro block in the adjacent view reference image of the current macro block, the sixth module 22 is configured to obtain the image block corresponding to the current macro block in the adjacent view reference image according to the disparity vector information, the seventh module 23 is configured to obtain coordinate information of the macro block corresponding to the current macro block according to the first offset information in the coordinate system of a reference image searching area established according to the image block, and the eighth module 24 is configured to obtain motion information of the macro block corresponding to the current macro block according to the coordinate information, and perform motion compensation by using the motion information.

Specifically, after receiving the code stream information, the fifth module 21 in the video decoding device 2 parses the received code stream information, and obtains the offset information of a corresponding macro block in the reference image of the macro block decoded currently. The seventh module 23 establishes a 2D coordinate system within the scope of the reference image searching area according to the image block found by the sixth module 22, so as to obtain the coordinate information of the corresponding macro block. The eighth module 24 extracts the motion information of the corresponding macro block from the motion information of all the decoded macro blocks of the reference image, and performs the motion compensation by using the motion information of the corresponding macro block as the motion information of the current macro block.

Further, the fifth module 21 includes a tenth sub-module 211, an eleventh sub-module 212, and a twelfth sub-module 213. The tenth sub-module 211 is configured to determine second offset information and third offset information of the corresponding macro blocks in the reference image of the macro blocks of respective peripheral blocks, for example, a left block and an upper block, of the current macro block, the eleventh sub-module 212 is configured to obtain decoding context information according to the second offset information and the third offset information, and the twelfth sub-module 213 is configured to parse the decoding context information to obtain the first offset information.

The video decoding device 2 further includes a ninth module 25, configured to parse marking symbol information for indicating a front or back view. After the code stream information is received, it is determined whether encoding information of the marking symbol exists. If yes, the ninth module 25 is used to parse the marking symbol information, and determines the corresponding macro block of the macro block decoded currently is located in the reference mage of which view.

FIG. 13 is a schematic structural view of a second embodiment of the video processing system according to the present invention. Referring to FIG. 13, the system includes a video encoding device 1 and a video decoding device 2. The video encoding device 1 includes a first module 11, a second module 12, and a third module 13. The first module 11 is configured to obtain an image block corresponding to a current macro block and having a size the same as a preset searching precision in an adjacent view reference image according to disparity vector information of the preset searching precision, the second module 12 is configured to obtain first offset information of a corresponding macro block capable of achieving an optimal encoding efficiency of the current macro block in a coordinate system established according to the image block, and the third module 13 is configured to encode the first offset information.

Specifically, the first module 11 in the video encoding device 1 initially designates an image block in the reference image according to the disparity vector information of the searching precision, where the size of the image block is the same as that of the searching precision. Then, the second module establishes a 2D coordinate system in a reference image searching area according to the image block, and thus, all the macro blocks in the reference image have position information according to the coordinate system. After the corresponding macro block capable of achieving the optimal encoding efficiency of the current macro block is found according to a certain searching sequence, the second module obtains the first offset information of the corresponding macro block, that is, offset information relative to an origin of coordinates. The third module 13 encodes the first offset information. Further, the third module 13 includes a fourth sub-module 134, a fifth sub-module 135, a sixth sub-module 136, and a seventh sub-module 137. The fourth sub-module 134 determines second offset information and third offset information of the corresponding macro blocks in the reference image of the macro blocks of respective peripheral blocks, for example, a left block and an upper block, of the current macro block, the fifth sub-module 135 averages corresponding components of the second offset information and the third offset information, and predicts the first offset information by using an averaging result, so as to obtain predicted residual information, the sixth sub-module 136 obtains encoding context information according to the second offset information and the third offset information, and the seventh sub-module 137 encodes the predicted residual information by using the encoding context information.

In the second embodiment of the video processing system, the video encoding device 1 further includes a fourth module 14, configured to encode marking symbol information for indicating a front or back view. Specifically, the fourth module 14 includes an eighth sub-module 141 and a ninth sub-module 142, where the eighth sub-module 141 performs XOR processing on the marking symbol for indicating the front or back view of the current macro block and a marking symbol of one or more peripheral macro blocks, and the ninth sub-module 142 is configured to establish a context model according to the marking symbol of the one or more peripheral macro blocks, and encode the marking symbol information after the XOR processing.

The video decoding device 2 includes a fifth module 21, a sixth module 22, a seventh module 23, and an eighth module 24. The fifth module 21 is configured to parse received code stream information, and obtain the first offset information of the macro block corresponding to the current macro block in the adjacent view reference image of the current macro block, the sixth module 22 is configured to obtain the image block corresponding to the current macro block in the adjacent view reference image according to the disparity vector information, the seventh module 23 is configured to obtain coordinate information of the macro block corresponding to the current macro block according to the first offset information in the coordinate system of a reference image searching area established according to the image block, and the eighth module 24 is configured to obtain motion information of the macro block corresponding to the current macro block according to the coordinate information, and perform motion compensation by using the motion information.

Specifically, after receiving the code stream information, the fifth module 21 in the video decoding device 2 parses the received code stream information, and obtains the offset information of a corresponding macro block in the reference image of the macro block decoded currently. The seventh module 23 establishes a 2D coordinate system within the scope of the reference image searching area according to the image block found by the sixth module 22, so as to obtain the coordinate information of the corresponding macro block. The eighth module 24 extracts the motion information of the corresponding macro block from the motion information of all the decoded macro blocks of the reference image, and performs the motion compensation by using the motion information of the corresponding macro block as the motion information of the current macro block.

Further, the fifth module 21 includes a thirteenth sub-module 214, a fourteenth sub-module 215, a fifteenth sub-module 216, and a sixteenth sub-module 217. The thirteenth sub-module 214 is configured to determine second offset information and third offset information of the corresponding macro blocks in the reference image of the macro blocks of respective peripheral blocks, for example, a left block and an upper block, of the current macro block, the fourteenth sub-module 215 is configured to obtain decoding context information according to the second offset information and the third offset information, the fifteenth sub-module 216 is configured to parse the decoding context information to obtain predicted residual information of the corresponding macro block, and the sixteenth sub-module 217 is configured to average corresponding components of the second offset information and the third offset information, and obtain the first offset information of the corresponding macro block according to a processing result and the predicted residual information.

The device further includes a ninth module 25, configured to parse the marking symbol information for indicating the front or back view. After the code stream information is received, it is determined whether encoding information of the marking symbol exists. If encoding information of the marking symbol exists, the ninth module 25 is use for parsing the marking symbol information, and determines the corresponding macro block of the macro block decoded currently is located in the reference mage of which view.

In the video encoding device of the video processing system according to the embodiments, ordinate and abscissa position information of each block in a searching area is established by selecting an appropriate origin of coordinates of the searching area; meanwhile, an offset of a current macro block is encoded by using information of peripheral blocks of the macro block encoded currently as a context for encoding position offset information of a corresponding macro block in an adjacent view reference image of the current macro block, so that the encoding efficiency is increased. In the video decoding device of the video processing system according to the embodiments, position information of the corresponding macro block in the coordinate system is obtained by parsing offset information of the corresponding macro block of the current macro block, and the motion information of the corresponding macro block is used as the motion information of the current macro block, so that the decoding efficiency is increased.

Finally, it should be noted that the above embodiments are merely provided for elaborating the technical solutions of the present invention, but not intended to limit the present invention. It should be understood by persons of ordinary skill in the art that although the present invention has been described in detail with reference to the foregoing embodiments, modifications or equivalent replacements can be made to the technical solutions without departing from the spirit and scope of the present invention.

What is claimed is:

1. A video encoding method, comprising:
obtaining an image block corresponding to a current macro block in an adjacent view reference image according to disparity vector information;
establishing a coordinate system of a reference image searching area of the image block according to the image block;
finding a corresponding macro block capable of achieving an optimal encoding efficiency of the current macro block in the searching area, and obtaining first offset information of the corresponding macro block in the coordinate system; and
encoding the first offset information.

2. The video encoding method according to claim 1, wherein the establishing the coordinate system of the reference image searching area of the image block according to the image block comprises:
using the image block or a first image block of the macro block of the image block as an origin of coordinates of the coordinate system of the reference image searching area.

3. The video encoding method according to claim 1, wherein the encoding the first offset information comprises:
determining offset information of corresponding macro blocks in the reference image of macro blocks of respective peripheral blocks of the current macro block;
obtaining encoding context information according to the offset information of the corresponding macro blocks in the reference image of the macro blocks of the respective peripheral blocks; and
encoding the first offset information by using the encoding context information.

4. The video encoding method according to claim 3, wherein the encoding the first offset information by using the encoding context information comprises:
binarizing the first offset information by using truncated unary code or exponential-Golomb code to obtain binary bit stream information; and
encoding the binary bit stream according to the encoding context information.

5. The video encoding method according to claim 3, wherein the encoding the first offset information by using the encoding context information comprises:
encoding the first offset information to a code stream by using truncated unary code or exponential-Golomb code.

6. The video encoding method according to claim 1, wherein the encoding the first offset information comprises:
determining offset information of corresponding macro blocks in the reference image of macro blocks of respective peripheral blocks of the current macro block;
averaging corresponding components of the offset information of the corresponding macro blocks in the reference image of the macro blocks of the respective peripheral blocks, and predicting the first offset information by using an averaging result, so as to obtain predicted residual information;
obtaining encoding context information according to the offset information of the corresponding macro blocks in the reference image of the macro blocks of the respective peripheral blocks; and
encoding the predicted residual information by using the encoding context information.

7. The video encoding method according to claim 6, wherein the encoding the predicted residual information by using the encoding context information comprises:
binarizing the first offset information by using truncated unary code or exponential-Golomb code to obtain binary bit stream information; and
encoding the binary bit stream according to the encoding context information.

8. The video encoding method according to claim 6, wherein the encoding the predicted residual information by using the encoding context information comprises:
encoding each component of the first offset information to a code stream by using truncated unary code or exponential-Golomb code.

9. The video encoding method according to claim 1, wherein after encoding the first offset information, the method further comprises encoding marking symbol information for indicating a front or back view.

10. The video encoding method according to claim 9, wherein the encoding the marking symbol information for indicating the front or back view comprises:
performing Exclusive-OR, XOR, processing on the marking symbol for indicating the front or back view of the current macro block and a marking symbol of one or more peripheral macro blocks; and
establishing a context model according to the marking symbol of the one or more peripheral macro blocks, and encoding the marking symbol information after the XOR processing by using the context model.

11. A video decoding method, comprising:
parsing received code stream information, and obtaining first offset information of a macro block corresponding to a current macro block in an adjacent view reference image of the current macro block;
obtaining an image block corresponding to the current macro block in the adjacent view reference image according to disparity vector information;
obtaining coordinate information of the macro block corresponding to the current macro block according to the first offset information in a coordinate system of a reference image searching area established according to the image block; and
obtaining motion information of the macro block corresponding to the current macro block according to the coordinate information, and performing motion compensation by using the motion information.

12. The video decoding method according to claim 11, wherein the parsing the received code stream information and obtaining the first offset information of the macro block corresponding to the current macro block in the adjacent view reference image of the current macro block comprises:
determining offset information of corresponding macro blocks in the reference image of macro blocks of respective peripheral blocks of the current macro block;
obtaining decoding context information according to the offset information of the corresponding macro blocks in the reference image of the macro blocks of the respective peripheral blocks; and
parsing the decoding context information to obtain the first offset information.

13. The video decoding method according to claim 12, wherein the parsing the decoding context information to obtain the first offset information comprises:
parsing the decoding context information to obtain the first offset information by using truncated unary code or exponential-Golornb code.

14. The video decoding method according to claim 11, wherein the parsing the received code stream information and obtaining the first offset information of the macro block corresponding to the current macro block in the adjacent view reference image of the current macro block comprises:
determining offset information of corresponding macro blocks in the reference image of macro blocks of respective peripheral blocks of the current macro block;
obtaining decoding context information according to the offset information of the corresponding macro blocks in the reference image of the macro blocks of the respective peripheral blocks;
parsing the decoding context information to obtain predicted residual information of the corresponding macro block; and
averaging corresponding components of the offset information of the corresponding macro blocks in the reference image of the macro blocks of the respective peripheral blocks, and obtaining the first offset information of the corresponding macro block according to a processing result and the predicted residual information.

15. The video decoding method according to claim 14, wherein the parsing the decoding context information to obtain the predicted residual information of the corresponding macro block comprises:
parsing the decoding context information to obtain the first offset information by using truncated unary code or exponential-Golomb code.

16. The video decoding method according to claim 11, wherein before the parsing the received code stream information and obtaining the first offset information of the macro block corresponding to the current macro block in the adjacent view reference image of the current macro block, the method further comprises parsing marking symbol information for indicating a front or back view.

17. The video decoding method according to claim 16, wherein the parsing the marking symbol information for indicating the front or back view comprises:
establishing a context model according to a marking symbol of one or more peripheral macro blocks of the current macro block, and parsing identification information of the marking symbol, wherein the identification information of the marking symbol is result information of performing Exclusive-OR, XOR, processing on the marking symbol of the current macro block and the marking symbol of the one or more peripheral macro blocks; and
performing the XOR processing on a parsing result to obtain the marking symbol information for indicating the front or back view.

18. A video encoding device, comprising:
a first module, configured to obtain an image block corresponding to a current macro block and having a size the same as a preset searching precision in an adjacent view reference image according to disparity vector information of the preset searching precision;
a second module, configured to obtain first offset information of a corresponding macro block capable of achieving an optimal encoding efficiency of the current macro block in a coordinate system established according to the image block; and
a third module, configured to encode the first offset information.

19. The video encoding device according to claim 18, wherein the third module comprises:
a first sub-module, configured to determine offset information of corresponding macro blocks in the reference image of macro blocks of respective peripheral blocks of the current macro block;
a second sub-module, configured to obtain encoding context information according to the offset information of the corresponding macro blocks in the reference image of the macro blocks of the respective peripheral blocks; and
a third sub-module, configured to encode the first offset information by using the encoding context information.

20. The video encoding device according to claim 18, wherein the third module comprises:
a fourth sub-module, configured to determine offset information of corresponding macro blocks in the reference image of macro blocks of respective peripheral blocks of the current macro block;
a fifth sub-module, configured to average corresponding components of the offset information of the corresponding macro blocks in the reference image of the macro blocks of the respective peripheral blocks, and predict the first offset information by using an averaging result, so as to obtain predicted residual information;
a sixth sub-module, configured to obtain encoding context information according to the offset information of the corresponding macro blocks in the reference image of the macro blocks of the respective peripheral blocks; and
a seventh sub-module, configured to encode the predicted residual information by using the encoding context information.

21. The video encoding device according to claim 18, further comprising a fourth module, configured to encode marking symbol information for indicating a front or back view.

22. The video encoding device according to claim 21, wherein the fourth module comprises:
an eighth sub-module, configured to perform Exclusive-OR, XOR, processing on the marking symbol for indicating the front or back view of the current macro block and a marking symbol of one or more peripheral macro blocks; and
a ninth sub-module, configured to establish a context model according to the marking symbol of the one or more peripheral macro blocks, and encode the marking symbol information after the XOR processing.

23. A video decoding device, comprising:
a fifth module, configured to parse received code stream information, and obtain first offset information of a macro block corresponding to a current macro block in an adjacent view reference image of the current macro block;
a sixth module, configured to obtain an image block corresponding to the current macro block in the adjacent view reference image according to disparity vector information;
a seventh module, configured to obtain coordinate information of the macro block corresponding to the current macro block according to the first offset information, in a coordinate system of a reference image searching area established according to the image block; and
an eighth module, configured to obtain motion information of the macro block corresponding to the current macro block according to the coordinate information, and perform motion compensation by using the motion information.

24. The video decoding device according to claim 23, wherein the fifth module comprises:
a tenth sub-module, configured to determine offset information of corresponding macro blocks in the reference image of macro blocks of respective peripheral blocks of the current macro block;
an eleventh sub-module, configured to obtain decoding context information according to the offset information of the corresponding macro blocks in the reference image of the macro blocks of the respective peripheral blocks; and
a twelfth sub-module, configured to parse the decoding context information to obtain the first offset information.

25. The video decoding device according to claim 23, wherein the fifth module comprises:
a thirteenth sub-module, configured to determine offset information of corresponding macro blocks in the reference image of macro blocks of respective peripheral blocks of the current macro block;
a fourteenth sub-module, configured to obtain decoding context information according to the offset information of the corresponding macro blocks in the reference image of the macro blocks of the respective peripheral blocks;
a fifteenth sub-module, configured to parse the decoding context information to obtain predicted residual information of the corresponding macro block; and
a sixteenth sub-module, configured to average corresponding components of the offset information of the corresponding macro blocks in the reference image of the macro blocks of the respective peripheral blocks, and obtain the first offset information of the corresponding macro block according to a processing result and the predicted residual information.

26. The video decoding device according to claim 23, further comprising a ninth module, configured to parse marking symbol information for indicating a front or back view.

27. A video processing system, comprising a video encoding device and a video decoding device, wherein
the video encoding device comprises:
a first module, configured to obtain an image block corresponding to a current macro block and having a size the same as a preset searching precision in an adjacent view reference image according to disparity vector information of the preset searching precision;
a second module, configured to obtain first offset information of a corresponding macro block capable of achieving an optimal encoding efficiency of the current macro block in a coordinate system established according to the image block; and
a third module, configured to encode the first offset information;
the video decoding device comprises:
a fifth module, configured to parse received code stream information, and obtain the first offset information of the macro block corresponding to the current macro block in the adjacent view reference image of the current macro block;
a sixth module, configured to obtain the image block corresponding to the current macro block in the adjacent view reference image according to the disparity vector information;
a seventh module, configured to obtain coordinate information of the macro block corresponding to the current macro block according to the first offset information in the coordinate system of a reference image searching area established according to the image block; and
an eighth module, configured to obtain motion information of the macro block corresponding to the current macro block according to the coordinate information, and perform motion compensation by using the motion information.

28. A video encoding method, comprising:
performing Exclusive-OR, XOR, processing on a marking symbol for indicating a front or back view of a current macro block and a marking symbol of one or more peripheral macro blocks; and
establishing a context model according to the marking symbol of the one or more peripheral macro blocks, and encoding the marking symbol information after the XOR processing by using the context model.
